(19) United States
(12) Patent Application Publication
(10) Pub. No.: US 2004/0038794 A1
(43) Pub. Date: Feb. 26, 2004

(54) System and method for producing a bound media body

(76) Inventor: Eric Hoarau, Pleasant Hill, CA (US)

Correspondence Address: HEWLETT-PACKARD COMPANY, Intellectual Property Administration, P.O. Box 272400, Fort Collins, CO, 80527-2400, US

(21) Appl. No.: 10/225,253

(22) Filed: Aug. 20, 2002

(51) Int. Cl. B05D 5/10

(52) U.S. Cl. 493/334

(57) ABSTRACT

A system and method for producing a bound media body utilizes individually folded sheets of media that have cuts on the folded edges. The folded sheets of media are formed by making cuts along a predefined line of the sheets of media and then folding the sheets of media along the cuts. The folded sheets of media are bound by adhesive material applied onto the folded edges of the sheets of media to form the bound media body.

### FIELD OF THE INVENTION

The invention relates generally to binding techniques, and more particularly to a system and method for producing a bound media body.

### BACKGROUND OF THE INVENTION

There are various techniques to bind sheets of paper to manufacture bound media bodies, such as textbooks, paperback books, booklets, pamphlets, catalogs and manuals. Popular binding techniques include wire-stitching, sewing and perfect binding techniques. In wire-stitching techniques, signatures (two or more folded sheets of paper stacked on top of each other) are fastened by wire staples through the centerfolds (saddle-stitching) or the sides near the centerfolds (side stitching). Wire-stitching techniques are commonly used to bind magazines and small booklets. Similar to wire-stitching techniques, in sewing techniques, signatures are fastened by threads, which are sewn through the centerfolds (saddle sewing) or the sides near the centerfolds (side sewing). Sewing techniques are commonly used to bind quality hard-back books. In perfect binding techniques, signatures or individual sheets of paper are glued to flexible adhesive material along the edges that form the spine of the bound media body. Perfect binding techniques are commonly used to bind paperback books, booklets and reference materials.

Among the different binding techniques, perfect binding techniques are most widely used due to low cost, quick processing time and quality of finished products. Perfect binding techniques vary with respect to the method of preparing the binding edges of signatures or individual sheets of paper to be glued to the flexible adhesive material. Since the binding strength of the bound media bodies produced using the perfect binding techniques depends on the adhesion of signatures or individual sheets of paper to the flexible adhesive material, the edge preparation method is an important part of a perfect binding technique to ensure pages of the resulting bound media bodies are securely fastened to the flexible adhesive material. Various methods exist to prepare the binding edges of signatures or individual sheets of paper. One edge preparation method involves making slits on the binding edges of stacked sheets of paper using a large wheel with teeth. Another edge preparation method involves milling the folded edges of stacked signatures using a grinder to produce rough edges on the resulting individual sheets of paper.

A concern with the slitting and milling methods is that dangerous heavy machinery is needed to make the slits on the binding edges of the stacked sheets of paper or to mill the folding edges of the stacked signatures. For the slitting method, another concern is that the depth of the slits is hard to control. For the milling method, another concern is that a significant amount of paper dust is created, which can interfere with the proper operation of the machinery. Furthermore, for the milling method, the resulting sheets of paper must be subsequently trimmed at three sides (excluding the milled side), creating paper waste, which is difficult to handle and collect for disposal.

Other edge preparation methods include notch and burst binding methods. In the notch binding method, notches are made on the folded edges of signatures by removing small sections of the signatures to allow penetration of the adhesive material into the individual folded sheets of the signatures through the holes formed by the notches to secure these sheets to the adhesive material. Similarly, in the burst binding method, large cuts are made on the folded edges of the signatures to allow penetration of the adhesive material into the individual folded sheets of the signatures through the cuts.

A concern with the notch and burst binding methods is that heavy machinery is needed to fold sheets of paper to form the signatures and then to make notches or cuts in the signatures. Another concern is that the interior sheets of the signatures are bound only at the notches or the cuts. Thus, these interior sheets of the signatures are not securely fastened as the exterior sheets of the signatures. Still another concern is that, similar to the milling method, subsequent trimming is required on three sides (excluding the side with the notches or the cuts), creating paper waste. For the notch binding method, still another concern is that additional paper waste is created when the notches are made.

In view of these concerns, what is need is a system and method for producing a bound media body having increased binding strength without generating significant amounts of paper waste and dust.

### SUMMARY OF THE INVENTION

A system and method for producing a bound media body utilizes individually folded sheets of media having cuts on the folded edges. The use of folded sheets of media with cuts on the folded edges increases the binding strength of the resulting bound media body by allowing adhesive material to penetrate into the folded sheets of media. In addition, media fibers that are exposed by the cuts on the folded edges of the folded sheets of media strengthen the adhesion between the adhesive material and the folded sheets of media, which also increases the binding strength of the resulting bound media body. Consequently, the system and method allows coated media to be effectively bound using a perfect binding technique.

A system in accordance with the invention includes a cutting unit, a folding unit and an applying unit. The cutting unit is configured to make cuts in sheets of media along a predefined line, such as the centerline of the sheets of media. The folding unit is configured to fold each of the sheets of media along the cuts such that the cuts are on the folded edges of the sheets of media. The applying unit is configured to apply adhesive material onto the folded edges of the sheet of media to form a bound media body.

A method in accordance with the invention includes providing sheets of media to be processed, making cuts in the sheets of media along a predefined line (e.g., the centerline), folding each of the sheets of media along the cuts such that the cuts are on the folded edges of the sheets of media, and applying adhesive material onto the folded edges of the sheets of media to bind the sheets of media to form the bound media body.

In an embodiment, the method further includes stacking the folded sheets of media side-by-side such that each of the folded edges of the folded sheets of media is exposed.

Other aspects and advantages of the present invention will become apparent from the following detailed description, taken in conjunction with the accompanying drawings, illustrated by way of example of the principles of the invention.

### BRIEF DESCRIPTION OF THE DRAWINGS

FIG. 1 is a diagram of a media binding system in accordance with the present invention.

FIG. 2 is a flow diagram of a perfect binding technique employed by the media binding system.

FIG. 3 illustrates perforations in the form of cuts that are made in a printed sheet of media in accordance with the perfect binding technique.

FIG. 4 illustrates a single folded sheet of media that is formed by folding the printed sheet of media along the perforations in accordance with the perfect binding technique.

FIG. 5 illustrates individually folded sheets of media with perforations that are stacked side-by-side for application of adhesive material in accordance with the perfect binding technique.

FIG. 6 illustrates a bound media body produced in accordance with the perfect binding technique.

FIG. 7 is a flow diagram of a method for producing a bound media body in accordance with the present invention.

### DETAILED DESCRIPTION

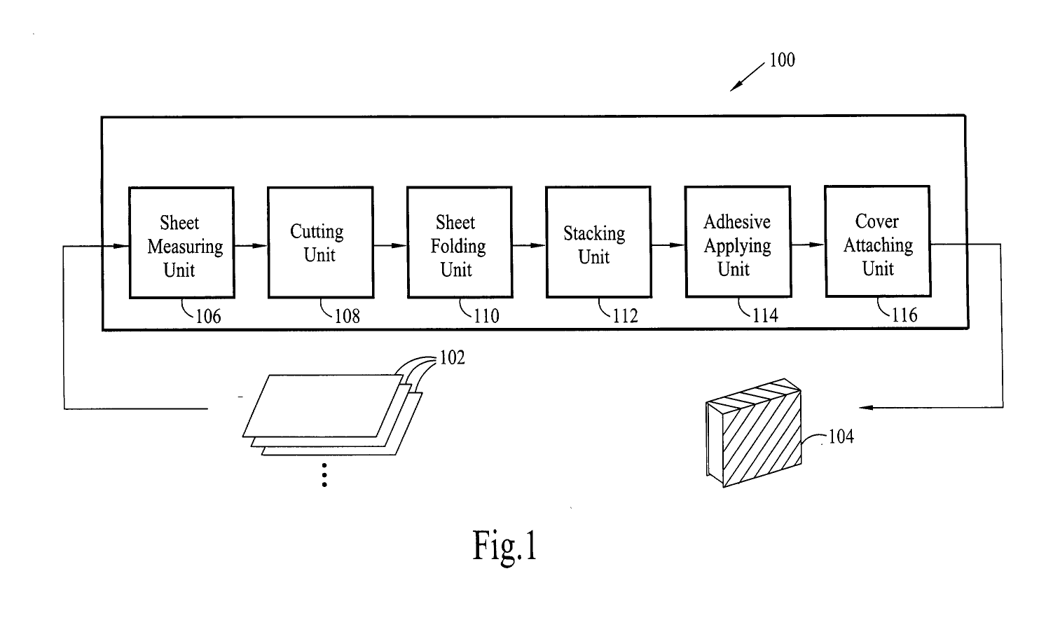

With reference to FIG. 1, a media binding system 100 in accordance with the invention is shown. The media binding system operates to bind printed media 102, which may be printed sheets of paper or other comparable material, to produce a bound media body 104, such as a paperback book, a booklet or a reference material, using a perfect binding technique. The perfect binding technique employed by the media binding system produces bound media bodies with increased binding strength in comparison with conventional perfect binding techniques. In addition, the perfect binding technique employed by the media binding system allows the system to generate significantly lower amounts of paper waste and dust than conventional perfect binding techniques. Furthermore, the perfect binding technique employed by the media binding system increases the throughput of the system.

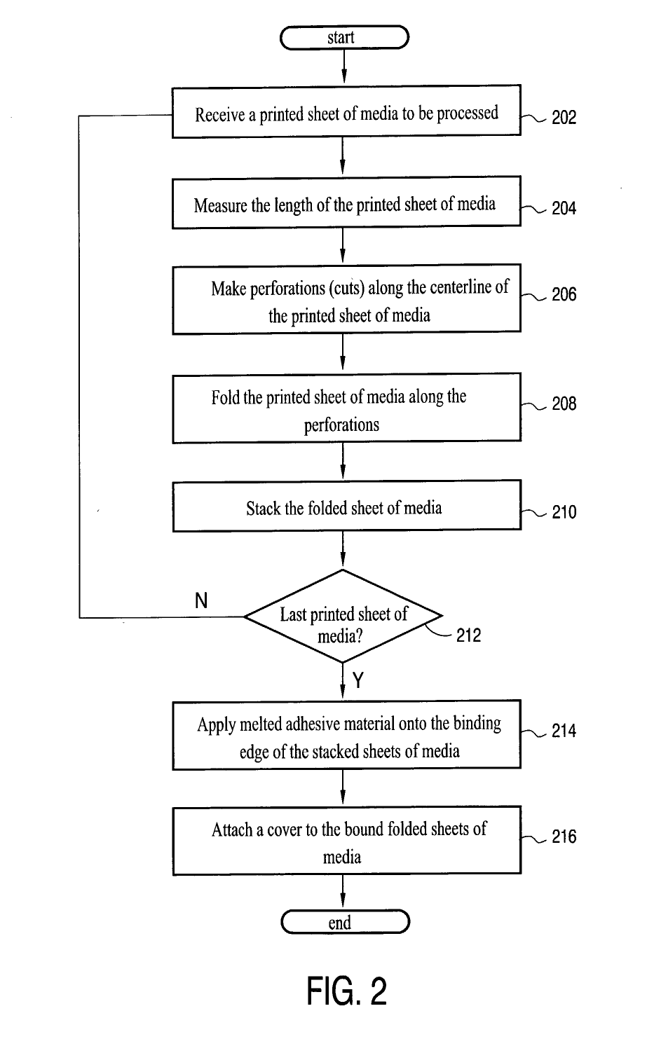

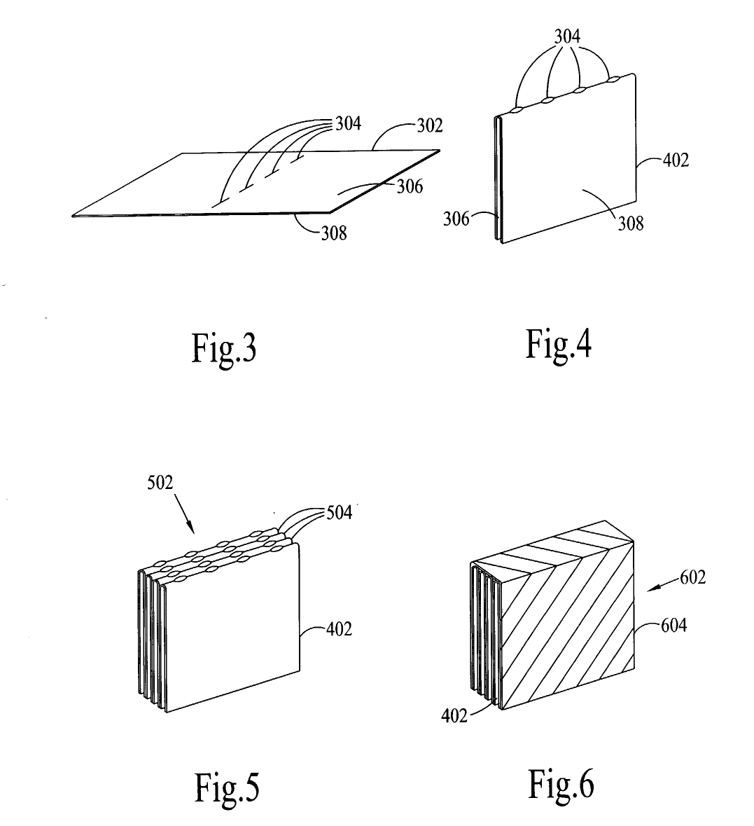

The perfect binding technique employed by the media binding system 100 is described with reference to FIGS. 2-6. FIG. 2 is a process flow diagram of the perfect binding technique. FIGS. 3-6 are illustrations of an exemplary printed sheet of media 302 being processed to produce a bound media body 602 in accordance with the perfect binding technique. The printed sheet of media may be a printed sheet of paper, such as coated paper. However, the printed sheet of media may be a sheet made of other comparable material. With reference to FIG. 2, a printed sheet of media, e.g., the printed sheet of media 302, is received to be processed, at step 202. As described below, the printed sheet of media is formed into a single folded sheet of media. Thus, the size of the printed sheet of media is at least twice as large as the desired page size of the resulting bound media body. As an example, the size of the printed medium may be twelve by nine inches (12″×9″). Next, at an optional step 204, the length of the printed sheet of media is measured to determine the centerline of the printed sheet of media. The measuring of the printed sheet of media ensures that slight variations in length from one printed sheet of media to the next are taken into account to more precisely determine the centerline. The precise determination of the centerline results in individually folded sheets of media that are substantially equivalent in size. Consequently, the sides of these individually folded sheets of media do not have to be subsequently trimmed to produce a bound media body with same sized pages.

Next, at step 206, perforations in the form of short cuts are made in the printed sheet of media along the centerline, as illustrated in FIG. 3 that depicts perforations 304 made in the printed sheet of media 302. In the exemplary embodiment, the short cuts are substantially straight cuts made in the direction of the centerline. These perforations are made without removing any portions of the printed sheet of media. Consequently, virtually no paper waste is generated as a result of this processing step. In addition, only minimal amount of paper dust is generated during this processing step. The perforations made in the printed sheet of media may be approximately 0.5 to 4 mm in length separated by a distance of 1 to 2 mm. As an example, the perforations may be 3 mm in length separated by a distance of 1.5 mm. Although the printed sheet of media 302 in FIG. 3 is shown with only four perforations 304, the printed sheets of media that are processed in accordance with the perfect binding technique may include fewer or more perforations. The perforations can be made by inserting one or more blades (not shown) through the printed sheet of media. In an embodiment, the perforations are made such that the perforation edges are rough and full of exposed media fibers. As an example, dull and/or serrated blades can be used to make the perforations to achieve the desired result on the perforations edges. The use of dull and/or serrated blades increases the number of media fibers, e.g., paper fibers, that are exposed on the perforation edges. As described in more detail below, the exposed media fibers help increase the binding strength of the resulting bound media body. Other techniques to expose media fibers on the perforation edges can also be used. For example, the size of a slot that receives a blade as the blade penetrates the printed sheet of media to make perforations may be increased so that media fibers on the perforation edges are exposed.

Next, at step 208, the printed sheet of media is folded along the perforations, i.e., the centerline, to form a single folded sheet of media, as illustrated in FIG. 4 that depicts a single folded sheet of media 402 formed from the printed sheet of media 302. Consequently, the perforation edges become part of the edge of the folded sheet of media where the printed sheet of media is folded. Thus, the exposed media fibers on the perforation edges are now on the folded edge of the folded sheet of media. In order to ensure that the exposed paper fibers are on the outside of the folded sheet of media, the printed sheet of media can be folded such that the surface of the printed sheet of media from where the perforations were made becomes the inner surface of the folded sheet of media. In the example of the printed sheet of media 302, if the perforations 304 were made from the top surface 306, shown in FIG. 3, the printed sheet of media is folded so that the top surface becomes the inner surface of the folded sheet of media 402 and the bottom surface 308 of the printed sheet of media becomes the outer surface of the folded sheet of media, as illustrated in FIG. 4.

Next, at step 210, the current folded sheet of media is stacked on top of a stack of previously processed printed sheets of media, if there are any, as illustrated in FIG. 5 that depicts the folded sheet of media 402 and other folded sheets of media 504 formed into a stack of folded sheets of media 502. Thus, the folded sheets of media are stacked side-by-side such that each folded edge of the folded sheets of media is exposed. That is, no folded sheet of media is inserted into another folded sheet of media. The folded edges of the stack of folded sheets of media form a binding surface, which will be the spine of the resulting bound media body.

Next, at step 212, a determination is made whether the current printed sheet of media is the last printed sheet of media to be processed. If the current printed sheet of media is not the last printed sheet of media to be processed, then the process proceeds back to step 202, where the next printed sheet of media to be processed is received. Steps 204-212 are then repeated for this printed sheet of media. However, if the current printed sheet of media is the last printed sheet of media to be processed, then the process proceeds to step 214, where melted adhesive material is applied onto the binding surface of the stack of folded sheets of media to bind the folded sheet of media together. The melted adhesive material is flexible adhesive material that has been heated to a temperature greater than the melting temperature of the adhesive material. Various types of adhesive material may be used to bind the folded sheets of media, including conventional hot-melt plastic material commonly used for binding paperback books. Since the binding surface of the stack of folded sheets of media is not milled or cut before applying the adhesive material, as is the case in some conventional perfect binding techniques, adjacent pages of the resulting bound media body are attached together at the fold of the respective folded sheet of media.

Next, at step 216, a cover is attached to the bound folded sheets of media to produce the bound media body, as illustrated by the bound media body 602 with a cover 604 in FIG. 6. The cover is attached to the bound folded sheets of media such that the spine of the bound media body is either floating or attached. The cover may be a hard cover or a soft cover.

There are a number of advantages of producing bound media bodies using the perfect binding technique in accordance with the invention. First, the exposed media fibers of the perforations on the binding surface of the stack of folded sheets of media help increase the adhesion between the folded sheets of media and the adhesive material. Consequently, the binding strength of the resulting bound media bodies is increased. Second, the perforations of the folded sheets of media on the binding surface allow the adhesive material to penetrate into the individual folded sheets of media, which also increases the adhesion between the folded sheets of media and the adhesive material. In addition, the perforations of the folded sheets of media increase the binding surface area of the stack of folded sheets of media, which also increases the binding strength of the resulting bound media bodies. Third, since the folded sheets of media are in tack when the adhesive material is applied to the binding surface of the stack of folded sheets of media, two adjacent pages of the bound media body are attached together at the fold of the respective folded sheet of media. Thus, as long as the folded sheets of media are attached to the adhesive material, individual pages will not fall out of the bound media body.

The use of folded sheets of media rather than individual pages to produce bound media bodies provides additional advantages. Since each folded sheet of media becomes two pages of a bound media body, fewer sheets of media need to be printed in order to print all of the pages that are to be included in the bound media body. Consequently, the pages of the bound media body can be printed much faster than if each page is printed on a separate sheet of media. In addition, since larger sheets of media are better handled by a printer and the sheets of media used to form the folded sheets of media are larger than the sheets of media used to form individual pages, the sheets of media used to form the folded sheet of media are better handled by a printer. Furthermore, since folded sheets of media are typically stiffer than individual sheets of media, the folded sheets of media are easier to handle and bind than individual sheets of media by a machine.

Turning back to FIG. 1, the components of the media binding system 100 in accordance with the invention is now described. The media binding system includes an optional sheet measuring unit 106, a cutting unit 108, a sheet folding unit 110, a stacking unit 112, an adhesive applying unit 114 and a cover attaching unit 116. These components perform the various steps of the described perfect binding technique to produce bound media bodies.

The optional sheet measuring unit 106 operates to measure the length of printed sheets of media, e.g., sheets of paper, that will be formed into individually folded sheets of media to more precisely determine the centerline of the printed sheets of media. Thus, the sheet measuring unit detects slight variations in the length of the printed sheets of media being processed. As an example, the sheet measuring unit may use optical sensors to detect the edges that define the length of the printed sheet of media to measure the length. In an embodiment, the sheet measuring unit may receive the printed sheets of media directly from a printer (not shown) that prints text, pictures, graphics, images and/or other patterns onto the sheets of media. In this embodiment, the media binding system 100 may include the printer. In another embodiment, the printed sheets of media to be processed may be manually introduced into the media binding system. In this embodiment, the media binding system may or may not include the printer.

The cutting unit 108 operates to produce perforations along the centerline of the printed sheets of media in the form of short cuts. In the exemplary embodiment, the short cuts are substantially straight cuts made in the direction of the centerline. The cutting unit may utilize one or more blades to make the perforations. In an embodiment, the blades of the cutting unit are dull and/or serrated so that the perforation edges are rough and full of exposed media fibers. In other embodiments, the cutting unit may employ other techniques to expose media fibers on the perforation edges. For example, the cutting unit may include one or more enlarged slots to receive the blades as the blades penetrate a printed sheet of media to make perforations so that media fibers on the perforation edges are exposed. The perforations made in the printed sheets of media may be approximately 0.5 to 4 mm in length separated by a distance of 1 to 2 mm. As an example, the perforations may be 3 mm in length separated by a distance of 1.5 mm.

The sheet folding unit 110 operates to individually fold each of the printed sheets of media along the perforations, i.e., the centerline, to form a single folded sheet of media. In an embodiment, the sheet folding unit folds each printed sheet of media such that the surface of the printed sheet of media from where the perforations were made becomes the inner surface of the folded sheet of media. Thus, the exposed media fibers of the perforations are on the outside of the folded sheet of media.

The stacking unit 112 operates to stack the folded sheets of media so that the adhesive applying unit 114 can apply melted adhesive material onto the binding surface of the stack of folded sheets of media. In the exemplary embodiment, the folded sheets of media are stacked side-by-side such that each folded edge of the folded sheets of media is exposed. Thus, when the adhesive material is applied to the binding surface of the stack of folded sheets of media, the adhesive material is directly applied to each folded sheet of media.

The cover attaching unit 116 operates to attach a cover to the bound folded sheets of media. The cover is attached to the bound folded sheets of media such that the spine of the bound media body is either floating or attached. The cover may be a hard cover or a soft cover.

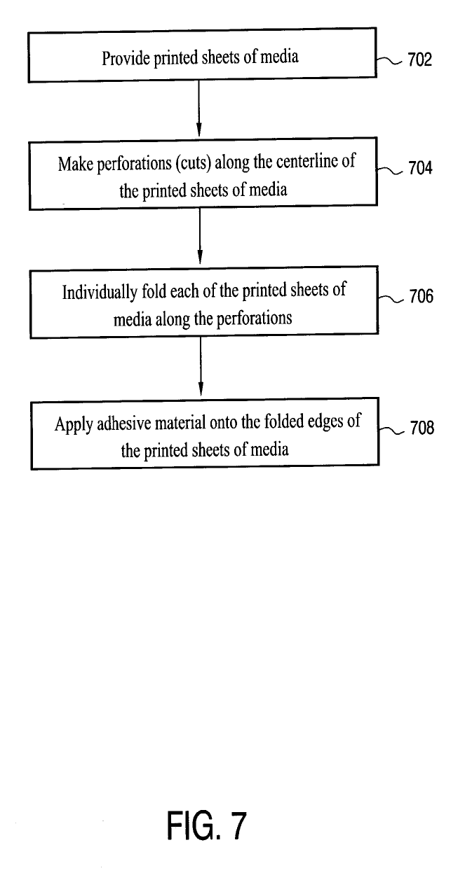

A method of producing a bound media body in accordance with the invention is described with reference to FIG. 7. At step 702, printed sheets of media to be processed are provided. The printed sheets of media may be sheets of paper, such as sheets of coated paper. Next, at step 704, perforations are made in each of the sheets of media along the centerline in the form of short cuts. In the exemplary embodiment, the short cuts are substantially straight cuts made in the direction of the centerline. At step 706, each of the sheets of media are individually folded along the perforations such that the perforations are located on the folded edges of the sheets of media. Next, at step 708, adhesive material is applied onto the folded edges of the printed sheets of media to form the bound media body. A cover can then be attached to the bound sheets of media to produce the final product.

Although a specific embodiment of the invention has been described and illustrated, the invention is not to be limited to the specific forms or arrangements of parts so described and illustrated. The scope of the invention is to be defined by the claims appended hereto and their equivalents.

What is claimed is:

1. A method for producing a bound media body comprising:
providing sheets of media to be processed;
making cuts in said sheets of media along a predefined line;
individually folding each of said sheets of media along said cuts such that said cuts are on folded edges of said sheets of media; and
applying an adhesive material onto said folded edges of said sheets of media to bind said sheets of media to form said bound media body.

2. The method of claim 1 wherein said making of said cuts include making substantially straight cuts in said sheets of media along said predefined line.

3. The method of claim 2 wherein said substantially straight cuts are orientated in the direction of said predefined line.

4. The method of claim 1 wherein said making of said cuts includes exposing media fibers on edges of said cuts.

5. The method of claim 1 wherein said individually folding of each of said sheets of media includes individually folding each of said sheets of media such that surfaces of said sheets of media from where said cuts were made becomes inner surfaces of said sheets of media when folded.

6. The method of claim 1 further comprising stacking said sheets of media side-by-side after each of said sheets of media is folded.

7. The method of claim 1 wherein said making of said cuts includes making said cuts in said sheets of media along the centerline of said sheets of media.

8. The method of claim 6 further comprising measuring lengths of said sheets of media to determine said centerline of said sheets of media.

9. The method of claim 1 wherein said sheets of media include sheets of paper.

10. A system for producing a bound media body comprising:
a cutting unit configured to make cuts in sheets of media along a predefined line;
a folding unit configured to individually fold each of said sheets of media along said cuts such that said cuts are on folded edges of said sheets of media; and
an applying unit configured to apply an adhesive material onto said folded edges of said sheets of media to form said bound media body.

11. The system of claim 10 wherein said cutting unit is configured to make substantially straight cuts in said sheets of media along said predefined line.

12. The system of claim 11 wherein said substantially straight cuts are orientated in the direction of said predefined line.

13. The system of claim 10 wherein said cutting unit includes at least one blade used to make said cuts in said sheets of media, said blade being configured to expose media fibers on edges of said cuts when said cuts are made.

14. The system of claim 10 wherein said folding unit is configured to individually fold each of said sheets of media such that surfaces of said sheets of media from where said cuts were made become inner surfaces of said sheets of media when folded.

15. The system of claim 10 further comprising a stacking unit configured to stack said sheets of media side-by-side after each of said sheets of media is folded.

16. The system of claim 10 wherein said cutting unit is configured to make said cuts in said sheets of media along the centerline of said sheets of media.

17. The system of claim 15 further comprising a measuring unit configured to measure lengths of said sheets of media to determine said centerline of said sheets of media.

18. A method for producing a bound media body comprising:
providing sheets of paper to be processed;
making cuts in said sheets of paper substantially along the centerline of said sheets of paper;
individually folding each of said sheets of paper along said cuts such that said cuts are on folded edges of said sheets of paper;
stacking said sheets of papers side-by-side such that each of said folded edges is exposed; and
applying an adhesive material onto said folded edges of said sheets to form said bound media body.

19. The method of claim 18 wherein said making of said cuts includes making substantially straight cuts in said sheets of paper substantially along said centerline of said sheets of media.

20. The method of claim 19 wherein said substantially straight cuts are orientated in the direction of said centerline of said sheets of paper.

21. The method of claim 18 wherein said individually folding of each of said sheet of paper includes individually folding each of said sheets of paper such that surfaces of said sheets of paper from where said cuts were made become inner surfaces of said sheet of paper when folded.
